(19) United States
(12) Patent Application Publication
(10) Pub. No.: US 2006/0001823 A1
(43) Pub. Date: Jan. 5, 2006

(54) ODF cell structure

(75) Inventor: Po-Sheng Shih, Taoyuan Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: HannStar Display Corporation

(21) Appl. No.: 11/030,354

(22) Filed: Jan. 6, 2005

(30) Foreign Application Priority Data
Jul. 1, 2004 (TW) 93119919

(51) Int. Cl. G02F 1/1339

(52) U.S. Cl. 349/153

(57) ABSTRACT

The present invention discloses an ODF cell structure. Any metal layer of a thin film transistor is arranged around a display region in a TFT array substrate so as to block the light leaking from the backlight module through the non-display region. An anti-reflection layer is partially formed over the metal layer to avoid the environmental light from being reflected by the metal layer.

### RELATED APPLICATIONS

The present application is based on, and claims priority from, Taiwan Application Serial Number 93119919, filed on Jul. 1, 2004, the disclosure of which is hereby incorporated by reference herein in its entirety.

### FIELD OF THE INVENTION

The present invention relates to a panel structure, and more particularly, to a panel structure for using one drop fill (ODF) technology.

### BACKGROUND OF THE INVENTION

Typical panel packaging comprises three main processes. The first process is a thin film transistor (TFT) array process that is similar to the semiconductor manufacturing process, except that transistors are fabricated on a glass substrate instead of a silicon wafer. The second process is to join the TFT array substrate and a front substrate that is fitted with a color filter. Then, the space between the two substrates is filled with liquid crystal. The third main process is a module assembly process for connecting additional components, such as driver integrated circuits and backlight units, to the fabricated glass panel. Typically, a vacuum filling technology is used to fill the liquid crystal molecules into the space between the color filter and the TFT array substrate. A frame seal 204 with a special opening 206 is arranged around the display region 202 in the TFT array substrate 200 as shown in the FIG. 1. This opening 206 is an injection opening for the liquid crystal molecules when the vacuum filling technology is processed.

FIG. 2 is a schematic diagram of the vacuum filling technology. When injecting liquid crystal molecules into the space between the two substrates, the panel 208 that finishes the joining of the TFT array substrate and the color filter substrate is firstly placed into a box 210 that is under vacuum. A base 212 is used to fix the panel 208. A container 214 filled with liquid crystal molecules is placed under the panel 208 for providing liquid crystal molecules to the panel 208. Since the box 210 is under vacuum, the liquid crystal molecules are drawn into the panel 208 through the injection opening 206.

However, mass production is not feasible because using the vacuum filling technology to fill liquid crystal molecules is too slow. Therefore, another filling technology, one drop fill (ODF) technology, has been developed to resolve the foregoing problem. The ODF process is undergone after the frame seal is finished. The liquid crystal molecules are filled in the region surrounded by the frame seal. Then, the TFT array substrate and the front substrate that is fitted with a color filter are aligned to each other. After alignment of the two substrates, a UV light is used to heat the frame seal to join the two substrates.

FIG. 3A is a top view of a panel that uses an ODF technology to fill liquid crystal molecules. FIG. 3B is a cross-sectional view from the AA′ line of the FIG. 3A. Typically, a black matrix (BM) 302 is built around a display region 306 over the color filter substrate 300 to avoid light leaking from the backlight to influence the display region 306 over the TFT array substrate 312. Additionally, a fixed width is required to form the black matrix 302 so as to block the light leaking from the non-display region. Therefore, partial overlapping between the black matrix 302 and the shell 308 is necessary. However, the black matrix 302 does not overlap the frame seal 304 so as to keep the black matrix from blocking the UV light when heating the frame seal 304. These design requirements limit the possibility of further reducing the panel size. Therefore, engineers are pursuing how to reduce the panel size without increasing light leakage.

### SUMMARY OF THE INVENTION

The main purpose of the present invention is to provide a panel structure to reduce the volume of the panel and light leakage.

Another purpose of the present invention is to provide a panel structure that can accommodate the ODF technology to fill liquid crystal molecules.

Yet another purpose of the present invention is to provide a panel structure with low light leakage whose black matrix extending from the display region is reduced so as to reduce the area of the panel.

According to the above purposes of the present invention, any metal layer that is used to fabricate the thin film transistor is formed around the display region of the TFT array substrate so as to avoid the light from the backlight module being scattered out from the non-display region. A black color anti-reflection layer, such as a black color resin, is formed over the metal layer to avoid reflecting environmental light. All masking layers and anti-reflection layers are formed in the TFT array substrate so as to reduce the size of the color filter substrate. Therefore, the whole area of the panel can be reduced.

An additional masking layer is formed over the surface and around the display region of the TFT array substrate facing the backlight module. This masking layer is used to block the light passing through the non-display region as leaked light to avoid influencing the display of the panel.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic top view of a conventional panel that uses a vacuum filling technology to fill liquid crystal molecules;

FIG. 2 is a schematic diagram of a machine for processing the vacuum filling technology;

FIG. 3A is a top view of a panel that uses an ODF technology to fill liquid crystal molecules;

FIG. 3B is a cross-sectional view along the AA′ line of FIG. 3A;

FIG. 4 is a schematic diagram of a panel structure according to the first embodiment of the present invention;

FIG. 5 is a schematic diagram of a panel structure according to the second embodiment of the present invention;

FIG. 6 is a schematic diagram of a panel structure according to the third embodiment of the present invention;

FIG. 7 is a schematic diagram of a panel structure according to the fourth embodiment of the present invention; and

FIG. 8 is a schematic diagram of a panel structure according to the fifth embodiment of the present invention.

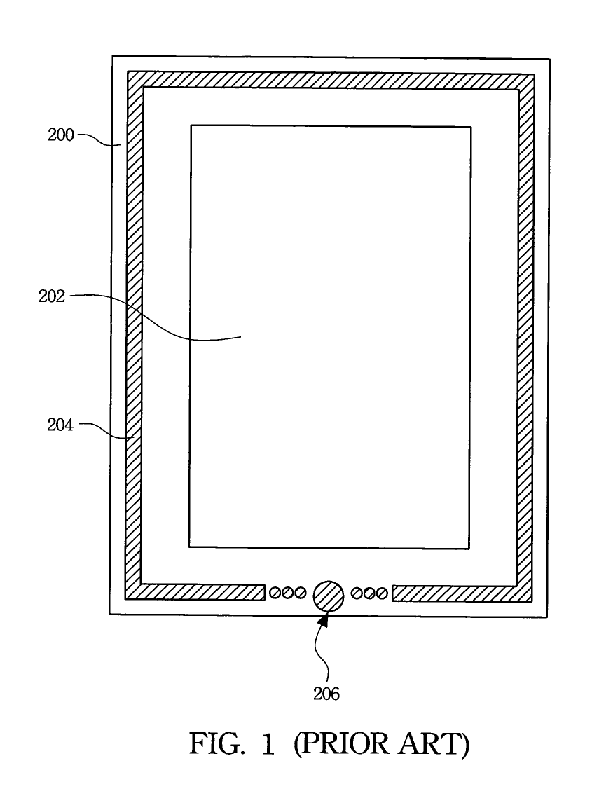

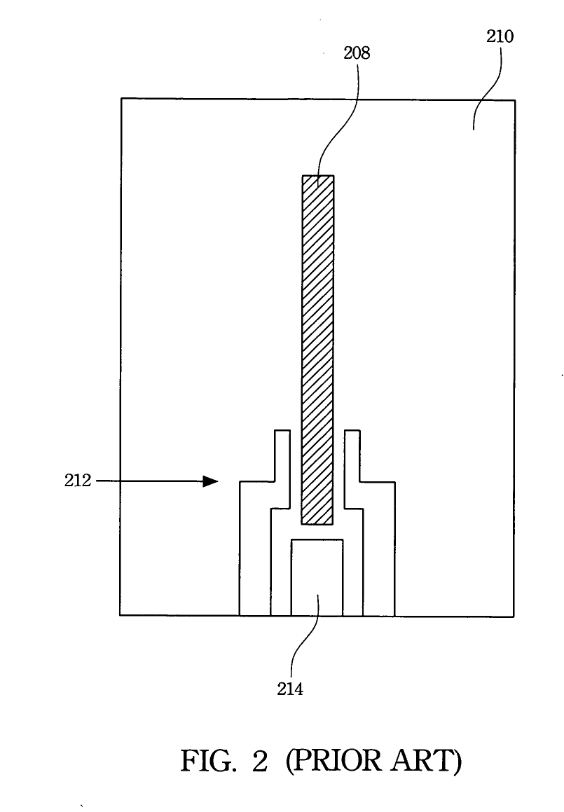

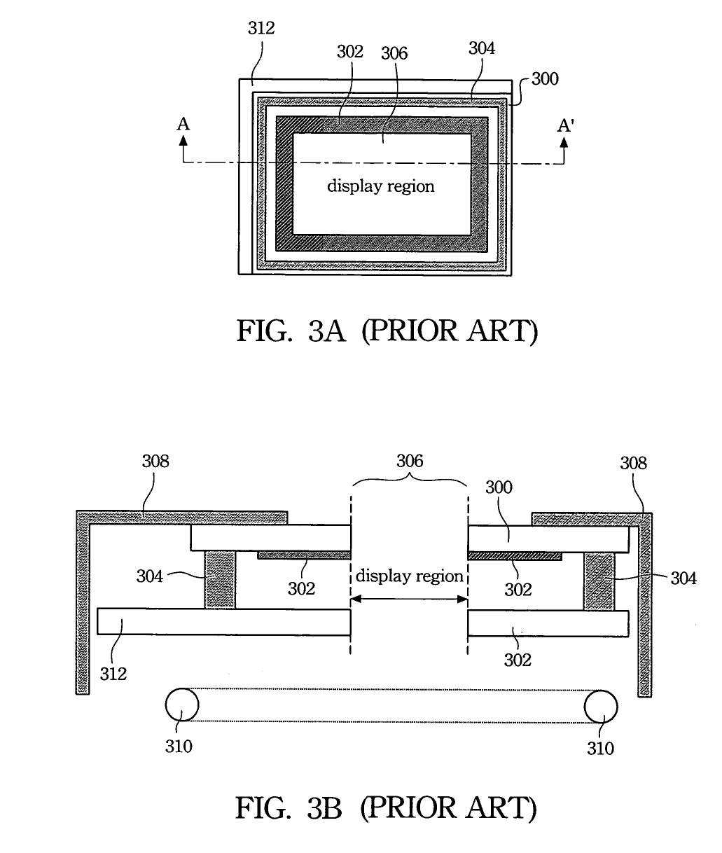

### DETAILED DESCRIPTION OF THE PREFERRED EMBODIMENT

### First Embodiment

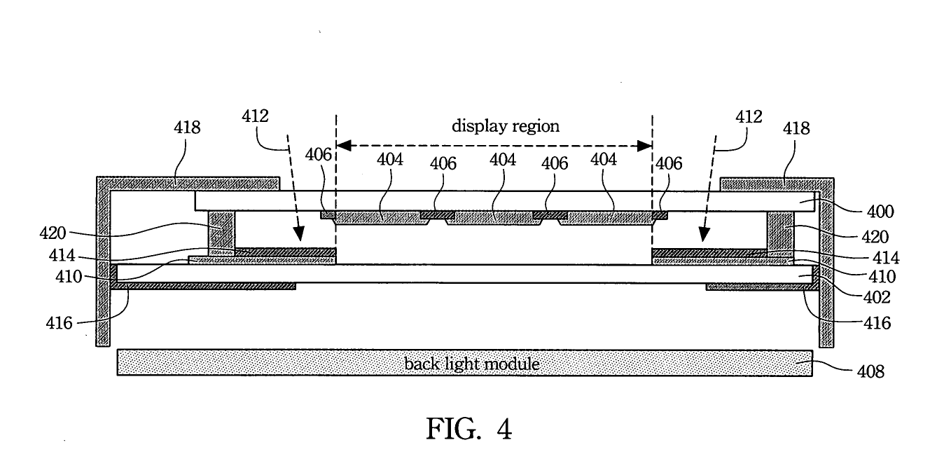

FIG. 4 is a schematic diagram of a panel structure according to the first embodiment of the present invention. A plurality of color filter films 404 whose color includes red, green and blue are formed over a color filter substrate 400. It is noticed that only three color filter films are represented in the FIG. 4. Black matrices 406 are formed between any two color filter films 404 to separate the color filter films and improve the contrast. A thin film transistor (TFT) array is formed over a substrate 402 to switch the corresponding liquid crystal molecule arrangement to determine whether or not the light can pass through the liquid crystal molecule layer. This thin film transistor array composes the display region of a liquid crystal display. A frame seal 420 is used to join the color filter substrate 400 and the TFT array substrate 402. A shell 418 is used to package these substrates and expose the display region.

Any metal layer 410 that is used to fabricate the thin film transistor array is extended from the display region and formed around the display region of the TFT array substrate 402 so as to keep the light from the backlight module 408 being scattered from the non-display region. The scattered light is the main source of the light leakage. Although the metal layer 410 can block the light from the backlight module 408, the metal layer 410 reflects the environmental light indicated by the arrow 412. The reflected environmental light is another source of light leakage. Therefore, a black color anti-reflection layer 414, such as a black color resin layer, is formed over the metal layer 410 to avoid the reflection of the environmental light. Any anti-reflection material can be used to form the anti-reflection layer 414. It is noticed that the anti-reflection layer 414 and the black matrix 406 are formed by the same material. Therefore, the anti-reflection layer 414 and the black matrix 406 can be formed together.

An additional masking tape 416 can also be formed over the surface of the TFT array substrate 402 facing the backlight module 408 to block the light passing through the non-display region. This masking tape 416 is formed around the TFT array substrate 402. In other words, an additional masking tape 416 is used in this embodiment to block the light leaking through the non-display region so as to avoid influencing the display of the panel. Other masking material can also be used to replace the masking tape 416.

Therefore, in this embodiment, a masking layer composed of a metal layer 410 and an anti-reflection layer 414, such as a black color resin layer, is formed over the TFT array substrate 402 to avoid light leakage. Additionally, a masking tape 416 is also formed over the surface of the TFT array substrate 402 facing the backlight module 408 to improve the capacity to avoid light leakage. All masking layers and masking tape are formed in the TFT array substrate 402 in the present invention. Therefore, it is not necessary to manage building the masking layer during fabricating the color filter substrate, hence can reducing the size of the panel.

### Second Embodiment

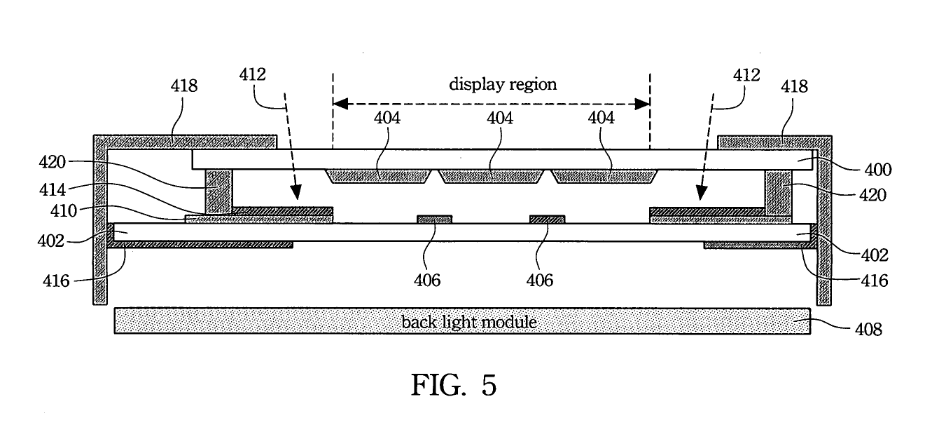

FIG. 5 is a schematic diagram of a panel structure according to the second embodiment of the present invention. A plurality of color filter films 404 whose color includes red, green and blue is formed over a color filter substrate 400. It is noticed that only three color filter films are represented in the FIG. 5. A thin film transistor (TFT) array is formed over a substrate 402 to switch the corresponding liquid crystal molecule arrangement to determine whether or not the light can pass through the liquid crystal molecule layer. This thin film transistor array composes the display region of a liquid crystal display. On the TFT array substrate 402, black matrices 406 are formed in the corresponding positions between any two color filter films 404. The main function of the black matrices 406 is to separate the color filter films 404 and improve the contrast. A frame seal 420 is used to join the color filter substrate 400 and the TFT array substrate 402. A shell 418 is used to package these substrates and expose the display region. According to the second embodiment, the black matrices 406 are formed on the TFT array substrate 402, which can simplify the manufacturing process of the color filter substrate 400.

Any metal layer 410 that is used to fabricate the thin film transistor array is extended from the display region and formed around the display region of the TFT array substrate 402 so as to avoid light from the backlight module 408 being scattered from the non-display region. The scattered light is the main source of the light leakage. Although the metal layer 410 can block the light from the backlight module 408, the metal layer 410 reflects the environmental light indicated by the arrow 412. The reflected environmental light is another source of light leakage. Therefore, a black color anti-reflection layer 414, such as a black color resin layer, is formed over the metal layer 410 to avoid the reflection of the environmental light. Any anti-reflection material can be used to form the anti-reflection layer 414. It is noticed that the anti-reflection layer 414 and the black matrix 406 are formed by the same material. Therefore, the anti-reflection layer 414 and the black matrix 406 can be formed together.

An additional masking tape 416 can also be formed over the surface of the TFT array substrate 402 facing the backlight module 408 to block the light passing through the non-display region. This masking tape 416 is formed around the TFT array substrate 402. In other words, an additional masking tape 416 is used in this embodiment to block the light leaking through the non-display region so as to avoid influencing the display of the panel. Other masking material can also be used to replace the masking tape 416.

Therefore, in this embodiment, a masking layer composed of a metal layer 410 and an anti-reflection layer 414, such as a black color resin layer, is formed over the TFT array substrate 402 to avoid light leakage. Additionally, a masking tape 416 is also formed over the surface of the TFT array substrate 402 facing the backlight module 408 to improve the capacity to avoid light leakage. All masking layers and masking tape are formed in the TFT array substrate 402 in the present invention. Therefore, it is not necessary to manage building the masking layer during fabricating the color filter substrate, thus reducing the size of the panel.

### Third Embodiment

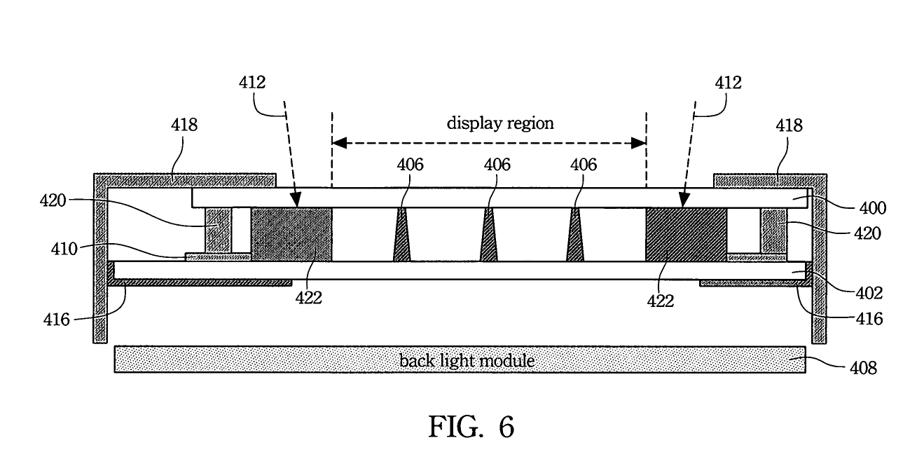

FIG. 6 is a schematic diagram of a panel structure according to the third embodiment of the present invention. A plurality of color filter films (not shown in this figure) whose color includes red, green and blue is formed over a color filter substrate 400. A thin film transistor (TFT) array is formed over a substrate 402 to switch the corresponding liquid crystal molecule arrangement to determine whether or not the light can pass through the liquid crystal molecule layer. This thin film transistor array composes the display region of a liquid crystal display. On the TFT array substrate 402, black matrices 406 are formed in the corresponding positions between any two color filter films. The main function of the black matrices 406 is to separate the color filter films and improve the contrast. Additionally, the black matrices 406 can serve as spacers between the TFT array substrate 402 and the color filter substrate 400. A frame seal 420 is used to join the color filter substrate 400 and the TFT array substrate 402. A shell 418 is used to package these substrates and expose the display region.

Any metal layer 410 that is used to fabricate the thin film transistor array is extended from the display region and formed around the display region of the TFT array substrate 402 so as to avoid the light from the backlight module 408 being scattered from the non-display region. The scattered light is the main source of light leakage. Although the metal layer 410 can block the light from the backlight module 408, the metal layer 410 reflects the environmental light indicated by the arrow 412. The reflected environmental light is another source of light leakage. Therefore, a black color anti-reflection layer 422, such as a black color resin layer, is formed over the metal layer 410 to avoid the reflection of the environmental light. Moreover, this black color anti-reflection layer 422 can also be formed independently of the metal layer 410. This black color anti-reflection layer 422 can serve as a spacer according to the embodiment. Any anti-reflection material can be used to form the anti-reflection layer 422. The anti-reflection layer 422 and the black matrix 406 are formed by the same material. Therefore, the anti-reflection layer 422 and the black matrix 406 can be formed together. Both of them can serve as spacers between the TFT array substrate 402 and the color filter substrate 400.

An additional masking tape 416 can also be formed over the surface of the TFT array substrate 402 facing the backlight module 408 to block the light leaking through the non-display region. This masking tape 416 is formed around the TFT array substrate 402. In other words, an additional masking tape 416 is used in this embodiment to block the light leaking through the non-display region so as to avoid influencing the display of the panel. Other masking material can also be used to replace the masking tape 416.

Similarly, in this embodiment, a masking layer that is composed of a metal layer 410 and an anti-reflection layer 422, such as a black color resin layer, is formed over the TFT array substrate 402 to avoid light leakage. Additionally, a masking tape 422 is also formed over the surface of the TFT array substrate 402 facing the backlight module 408 to improve the capacity to avoid light leakage. All masking layers and masking tape are formed in the TFT array substrate 402 in the present invention. Therefore, it is not necessary to manage building the masking layer during fabricating the color filter substrate, hence reducing the size of the panel.

### Fourth Embodiment

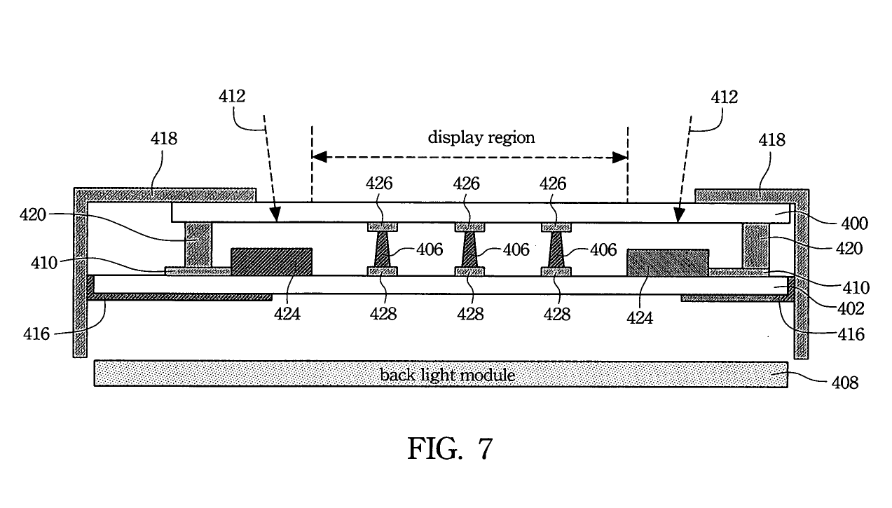

FIG. 7 is a schematic diagram of a panel structure according to the fourth embodiment of the present invention. A plurality of color filter films (not shown in this figure) whose color includes red, green and blue are formed over a color filter substrate 400. A thin film transistor (TFT) array is formed over a substrate 402 to switch the corresponding liquid crystal molecule arrangement to determine whether or not the light can pass through the liquid crystal molecule layer. This thin film transistor array composes the display region of a liquid crystal display. Black matrices 406 are formed between the color resins 426 over the color filter substrate 400 and the layer 428 over the TFT array substrate 402, wherein the layer 428 is the metal layer, the insulation layer or the amorphous silicon layer of the TFT array. The main function of the black matrices 406 is to separate the color filter films and improve the contrast. Additionally, the black matrices 406 can serve as spacers between the TFT array substrate 402 and the color filter substrate 400. A frame seal 420 is used to join the color filter substrate 400 and the TFT array substrate 402. A shell 418 is used to package these substrates and expose the display region.

Any metal layer 410 that is used to fabricate the thin film transistor array is extended from the display region and formed around the display region of the TFT array substrate 402 so as to avoid the light from the backlight module 408 being scattered from the non-display region. The scattered light is the main source of light leakage. Although the metal layer 410 can block the light from the backlight module 408, the metal layer 410 reflects the environmental light indicated by the arrow 412. The reflected environmental light is another source of light leakage. Therefore, a black color anti-reflection layer 424, such as a black color resin layer, is formed over or independent of the metal layer 410 to avoid the reflection of the environmental light. The position of the black color anti-reflection layer 424 is related to the thickness of the black color anti-reflection layer 424. Any anti-reflection material can be used to form the anti-reflection layer 424. The anti-reflection layer 424 and the black matrix 406 are formed by the same material. Therefore, the anti-reflection layer 424 and the black matrix 406 can be formed together.

The main difference between the fourth and third embodiments is the height between the anti-reflection layer 424 and the black matrix 406. The main purpose of the height difference is to control the cell gap during joining the color filter substrate 400 and the TFT array substrate 402. The height difference can serve as a buffer when applying pressure to the two substrates for joining. In other words, if there is no height difference, it is easy to break the substrate because of the arrangement density difference between the anti-reflection layer 424 and the black matrix 406.

An additional masking tape 416 can also be formed over the surface of the TFT array substrate 402 facing the backlight module 408 to block the light passing through the non-display region. This masking tape 416 is formed around the TFT array substrate 402. In other words, an additional masking tape 416 is used in this embodiment to block the light leaking through the non-display region in order to avoid influencing the display of the panel. Other masking material can also be used to replace the masking tape 416.

Similarly, in this embodiment, a masking layer that is composed of a metal layer 410 and an anti-reflection layer 422, such as a black color resin layer, is formed over the TFT array substrate 402 to avoid light leakage. Additionally, a masking tape 422 is also formed over the surface of the TFT array substrate 402 facing the backlight module 408 to improve the capacity to avoid light leakage. All masking layers and masking tape are formed in the TFT array substrate 402 in the present invention. Therefore, it is not necessary to manage building the masking layer during fabricating the color filter substrate, hence reducing the size of the panel.

### Fifth Embodiment

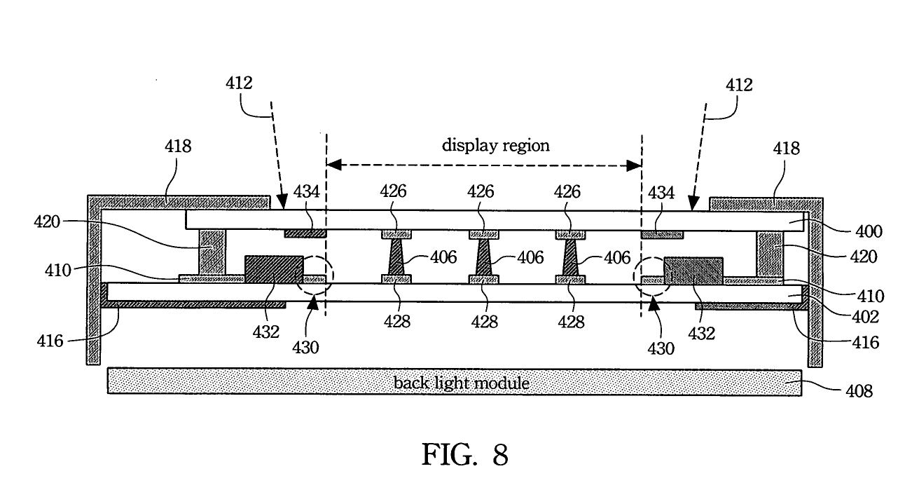

FIG. 8 is a schematic diagram of a panel structure according to the fifth embodiment of the present invention. A plurality of color filter films (not shown in this figure) whose color includes red, green and blue is formed over a color filter substrate 400. A thin film transistor (TFT) array is formed over a substrate 402 to switch the corresponding liquid crystal molecule arrangement to determine whether or not the light can pass through the liquid crystal molecule layer. This thin film transistor array composes the display region of a liquid crystal display. Black matrices 406 are formed between the color resins 426 over the color filter substrate 400 and the layer 428 over the TFT array substrate 402, wherein the layer 428 is the metal layer, the insulation layer or the amorphous silicon layer of the TFT array. The main function of the black matrices 406 is to separate the color filter films and improve the contrast. Additionally, the black matrices 406 can serve as spacers between the TFT array substrate 402 and the color filter substrate 400. A frame seal 420 is used to join the color filter substrate 400 and the TFT array substrate 402. A shell 418 is used to package these substrates and expose the display region.

Any metal layer 410 that is used to fabricate the thin film transistor array is extended from the display region and formed around the display region of the TFT array substrate 402 so as to avoid the light from the backlight module 408 being scattered from the non-display region. The scattered light is the main source of light leakage. Although the metal layer 410 can block the light from the backlight module 408, the metal layer 410 reflects the environmental light indicated by the arrow 412. The reflected environmental light is another source of light leakage. Therefore, a black color anti-reflection layer 432, such as a black color resin layer, is formed over or independent of the metal layer 410 to avoid the reflection of the environmental light. The position of the black color anti-reflection layer 432 is related to the thickness of the black color anti-reflection layer 432. Any anti-reflection material can be used to form the anti-reflection layer 432. The anti-reflection layer 432 and the black matrix 406 are formed by the same material. Therefore, the anti-reflection layer 432 and the black matrix 406 can be formed together.

The main difference between the fifth and third embodiment is the height between the anti-reflection layer 432 and the black matrix 406. The main purpose of the height difference is to control the cell gap during joining the color filter substrate 400 and the TFT array substrate 402. The height difference can serve as a buffer when applying pressure to the two substrates for joining. In other words, if there is no height difference, it is easy to break the substrate because of the arrangement density difference between the anti-reflection layer 432 and the black matrix 406.

Moreover, a metal layer 410 is exposed in the region 430 that is between the anti-reflection layer 432 and display region. The main purpose is to avoid a sharp change in height to influence the rubbing orientation process for the liquid crystal molecules. Since the region 430 is adjacent to the display region, the height change will influence the rubbing orientation process in the region adjacent to the region 430. Therefore, a anti-reflection layer 432 is not formed in the region 430 according to this embodiment so as to release the change in height in the region 430. However, an additional masking layer 434 is formed in a corresponding position in the color filter substrate 400 to keep the environmental light from being reflected by the metal layer 410 located in the region 430. The material for making the color filter films on the color filter substrate 400 can be used to form the masking layer 434. Therefore, the masking layer 434 and the color filter film can be formed together, which can simplify the whole process.

An additional masking tape 416 can also be formed over the surface of the TFT array substrate 402 facing the backlight module 408 to block the light passing through the non-display region. This masking tape 416 is formed around the TFT array substrate 402. In other words, an additional masking tape 416 is used in this embodiment to block the light leaking through the non-display region so as to avoid influencing the display of the panel. Other masking material can also be used to replace the masking tape 416.

Similarly, in this embodiment, a masking layer that is composed of a metal layer 410 and an anti-reflection layer 422, such as a black color resin layer, is formed over the TFT array substrate 402 to avoid light leakage. Additionally, a masking tape 422 is also formed over the surface of the TFT array substrate 402 facing the backlight module 408 to improve the capacity to avoid light leakage. All masking layers and masking tape are formed in the TFT array substrate 402 in the present invention. Therefore, it is not necessary to manage building the masking layer during fabricating the color filter substrate, thereby reducing the size of the panel.

According to the embodiments described above, the main masking layers and masking tape are formed in the TFT array substrate. Therefore, there are no masking layers or masking tape in the color filter substrate, which can reduce the whole area of the liquid crystal display.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A liquid crystal display panel structure, comprising:
a color filter substrate with a plurality of color films;
a thin film transistor (TFT) array substrate arranged in parallel with said color filter substrate and liquid crystal molecules sandwiches between said TFT array substrate and said color filter substrate, wherein a display region surrounded by a metal layer is formed over said TFT array substrate and a first masking layer partially covers said metal layer; and
a frame seal surrounding said first masking layer for joining said color filter substrate and said TFT array substrate together.

2. The structure of claim 1, wherein said metal layer is a metal layer of a thin film transistor.

3. The structure of claim 1, wherein said first masking layer is a black color matrix, a black color resin or a combination of them.

4. The structure of claim 1, wherein the material of said first masking layer is an anti-reflection material.

5. The structure of claim 1, further comprising a second masking layer is formed over another surface of said TFT array substrate facing said color filter substrate, wherein said second masking layer surrounds said display region.

6. The structure of claim 5, wherein said second masking layer is a masking tape.

7. The structure of claim 7, wherein said first masking layer serves as a spacer.

8. The structure of claim 1, further comprising a plurality of black matrices located between any two of adjacent color films.

9. The structure of claim 8, wherein said black matrices are located over said TFT array substrate.

10. The structure of claim 8, wherein said black matrices and said first masking layer are formed together.

11. The structure of claim 8, wherein said black matrices and said first masking layer are the same height.

12. The structure of claim 8, wherein said black matrices are located over said color filter substrate.

13. The structure of claim 8, wherein said black matrices serve as spacers.

14. A liquid crystal display panel structure, comprising:
a color filter substrate with a plurality of color films;
a TFT array substrate arranged in parallel with said color filter substrate, wherein a display region surrounded by a metal layer is formed over said TFT array substrate and a first masking layer partially covers said metal layer;
a plurality of black matrices located between any two of adjacent color films; and
a frame seal surrounding said first masking layer for joining said color filter substrate and said TFT array substrate together.

15. The structure of claim 14, wherein said metal layer is a metal layer of a thin film transistor.

16. The structure of claim 14, wherein said first masking layer is a black color matrix, a black color resin or a combination of them.

17. The structure of claim 14, wherein the material of said first masking layer is an anti-reflection material.

18. The structure of claim 14, further comprising a second masking layer is formed over another surface of said TFT array substrate facing said color filter substrate, wherein said second masking layer surrounds said display region.

19. The structure of claim 18, wherein said second masking layer is a masking tape.

20. The structure of claim 14, wherein said first masking layer serves as a spacer.

21. The structure of claim 14, wherein said black matrices are located over said TFT array substrate.

22. The structure of claim 14, wherein said black matrices and said first masking layer are formed together.

23. The structure of claim 14, wherein said black matrices and said first masking layer are the same height.

24. The structure of claim 14, wherein said black matrices are located over said color filter substrate.

25. The structure of claim 14, wherein said black matrices serve as spacers.
